(19) United States
(12) Patent Application Publication
(10) Pub. No.: US 2023/0064647 A1
(43) Pub. Date: Mar. 2, 2023

(54) SYNCHRONIZATION METHOD AND EMULATOR

(71) Applicant: XEPIC CORPORATION LIMITED, Nanjing (CN)

(72) Inventors: Xin XU, Shanghai (CN); Lanbing CHEN, Shanghai (CN)

(21) Appl. No.: 17/885,387

(22) Filed: Aug. 10, 2022

(30) Foreign Application Priority Data
Aug. 27, 2021 (CN) 202110995728.2

(51) Int. Cl. G06F 30/3308

(52) U.S. Cl. CPC G06F 30/3308; G06F 2115/02

(57) ABSTRACT

Embodiments of the disclosure provide a method for synchronizing a first module and a second module of a logic system design, wherein the first module and the second module operate according to a system clock, the first module includes a plurality of sub-modules, the method comprising: determining, among the plurality of sub-modules, whether a target sub-module generates an event indication; in response to determining that the target sub-module generates the event indication, switching a period of the system clock from a first clock period to a second clock period, wherein the first clock period is less than the second clock period; and running the target sub-module according to the second clock period.

### CROSS-REFERENCE TO RELATED APPLICATION

This application claims the benefits of priority to Chinese Application No. 202110995728.2, filed Aug. 27, 2021, the entire content of which is incorporated herein by reference.

### TECHNICAL FIELD

The present disclosure relates to the technical field of circuits, and in particular, to a synchronization method and an emulator.

### BACKGROUND

An emulator can emulate and debug a logic system design including one or more modules. The logic system design can be, for example, a design for an Application Specific Integrated Circuit (ASIC) or a System-On-Chip (SOC) for a specific application. Therefore, the logic system design to be tested in the emulator can also be referred to as a Design Under Test (DUT). The emulator can emulate the DUT through one or more configurable components (e.g., Field Programmable Gate Array (FPGA)), including performing various operations of the DUT, to test and verify the function of each module of the DUT before manufacturing.

As the size of the logic system design becomes larger, the emulation of a design usually requires the introduction of a plurality of configurable components. When the emulation needs to be performed on the plurality of configurable components, how to keep the communication synchronization between the configurable components is a problem that needs to be solved.

### SUMMARY

In accordance with the disclosure, there is provided a synchronization method and an emulator.

Embodiments of the disclosure provide a method for synchronizing a first module and a second module of a logic system design, wherein the first module and the second module operate according to a system clock, the first module includes a plurality of sub-modules, the method comprising: determining, among the plurality of sub-modules, whether a target sub-module generates an event indication; in response to determining that the target sub-module generates the event indication, switching a period of the system clock from a first clock period to a second clock period, wherein the first clock period is less than the second clock period; and running the target sub-module according to the second clock period.

Embodiments of the disclosure also provide an emulator for synchronizing a first module and a second module of a logic system design, comprising: an interface unit for being connected to a host; a memory for storing a set of instructions; and at least one processor configured to execute the set of instructions to perform a method for synchronizing a first module and a second module of a logic system design, wherein the first module and the second module operate according to a system clock, the first module includes a plurality of sub-modules, the method including: determining, among the plurality of sub-modules, whether a target sub-module generates an event indication; in response to determining that the target sub-module generates the event indication, switching a period of the system clock from a first clock period to a second clock period, wherein the first clock period is less than the second clock period; and running the target sub-module according to the second clock period.

Embodiments of the present disclosure provide a non-transitory computer-readable storage medium that stores a set of instructions of an emulator. The set of instructions is used to cause the emulator to perform a method for synchronizing a first module and a second module of a logic system design, wherein the first module and the second module operate according to a system clock, the first module includes a plurality of sub-modules, the method including: determining, among the plurality of sub-modules, whether a target sub-module generates an event indication; in response to determining that the target sub-module generates the event indication, switching a period of the system clock from a first clock period to a second clock period, wherein the first clock period is less than the second clock period; and running the target sub-module according to the second clock period.

### BRIEF DESCRIPTION OF THE DRAWINGS

To describe the technical solutions in the present disclosure more clearly, the following will briefly introduce the figures that need to be used in the embodiments. Obviously, the figures in the following description are merely exemplary, for those ordinary skilled in the art, without inventive work, other figures can be obtained based on these figures.

FIG. 1 illustrates a schematic structural diagram of an exemplary emulation system according to embodiments of the present disclosure.

FIG. 2A illustrates a schematic diagram of an emulator according to embodiments of the present disclosure.

FIG. 2B illustrates a schematic diagram of a delay generated by a verification board during data transmission according to embodiments of the present disclosure.

FIG. 3 illustrates a schematic diagram of an exemplary emulator according to embodiments of the present disclosure.

FIG. 4A illustrates a schematic diagram of an exemplary logic system design according to embodiments of the present disclosure.

FIG. 4B illustrates a schematic diagram of a delay of a sub-module of a design according to embodiments of the present disclosure.

FIG. 5A illustrates a schematic diagram of an exemplary system clock according to embodiments of the present disclosure.

FIG. 5B illustrates a schematic diagram of an exemplary state machine of a clock generator according to embodiments of the present disclosure.

FIG. 6 is a flowchart of an exemplary synchronization method according to embodiments of the present disclosure.

### DETAILED DESCRIPTION

Exemplary embodiments will be described in detail herein, and examples thereof are shown in the accompanying drawings. In the following description involving the accompanying drawings, the same numerals in different accompanying drawings indicate the same or similar elements, unless specified otherwise. Implementations described in the following exemplary embodiments do not represent all implementations consistent with the disclosure. In contrast, they are merely examples of devices and methods consistent with some aspects of the disclosure as described in detail in the appended claims.

Terms in the disclosure are merely used for describing specific embodiments, rather than limiting the disclosure. Singular forms “a (an)”, “said”, and “the” used in the present disclosure and the appended claims also include plural forms, unless clearly specified in the context that other meanings are denoted. It should be further understood that the term “and/or” used herein refers to and includes any or all possible combinations of one or more associated items listed.

It should be understood that, although terms such as “first”, “second”, and “third” can be used to describe various kinds of information in the disclosure, these kinds of information should not be limited by the terms. These terms are merely used to distinguish information of the same type from each other. For example, without departing from the scope of the disclosure, the first information can also be referred to as second information, and similarly, the second information can also be referred to as first information. Depending on the context, the word “if” used herein can be understood as “when . . . ”, “as . . . ”, or “in response to the determination”.

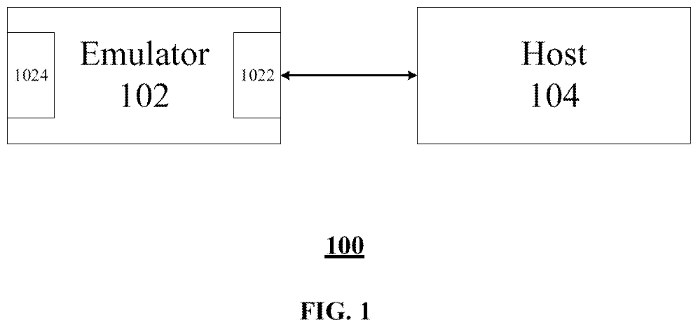

FIG. 1 illustrates a schematic structural diagram of an exemplary emulation system 100 according to embodiments of the present disclosure.

As shown in FIG. 1, emulation system 100 can include an emulator 102 and a host 104.

Emulator 102 is a hardware system for emulating a design under test (DUT). A DUT can include a plurality of modules. The DUT can be a combinational logic circuit, a sequential logic circuit, or a combination of both. Emulator 102 can include one or more verification boards, each can further include one or more configurable circuits (e.g., FPGAs) for emulating the DUT.

Emulator 102 can include an interface unit 1022 for communicatively coupling to host 104 for communication between host 104 and emulator 102. In some embodiments, interface unit 1022 can include one or more interfaces with electrical connection capabilities. For example, interface unit 1022 can include an RS232 interface, a USB interface, a LAN port, an optical fiber interface, an IEEE1394 (FireWire interface), and the like. In some embodiments, interface unit 1022 can be a wireless network interface. For example, interface unit 1022 can be a WIFI interface, a Bluetooth interface, or the like.

Emulator 102 can also include a memory 1024 for storing signal values generated by the DUT during emulation. In some embodiments, the signal values generated by the DUT during emulation can be read directly by host 104.

Host 104 can be used to configure emulator 102 to emulate a DUT. The DUT can be a complete logic system design or one or more target modules of a complete logic system design. In some embodiments, host 104 can be a virtual host in a cloud computing system. A logic system design (e.g., ASIC or System-On-Chip) can be designed in a hardware description language (e.g., Verilog, VHDL, System C, or System Verilog). In some embodiments, the logic system design can include one or more target modules to be debugged.

Host 104 can receive a request from a user to debug the DUT. As mentioned above, a DUT can include one or more modules. The description of the DUT and its modules can be done in a hardware description language. Host 104 can perform synthesis based on the description of the DUT and its modules to generate, for example, a gate-level netlist for the DUT.

As the increased size of chip designs, in some scenarios it may be needed to split the design and emulate it on FPGAs on a plurality of verification boards. Then communication between different verification boards (or different FPGAs) is needed. The inherent delays in communication across the verification boards (or across the FPGAs) can cause actions between different verification boards (or different FPGAs) to be out of synchronization.

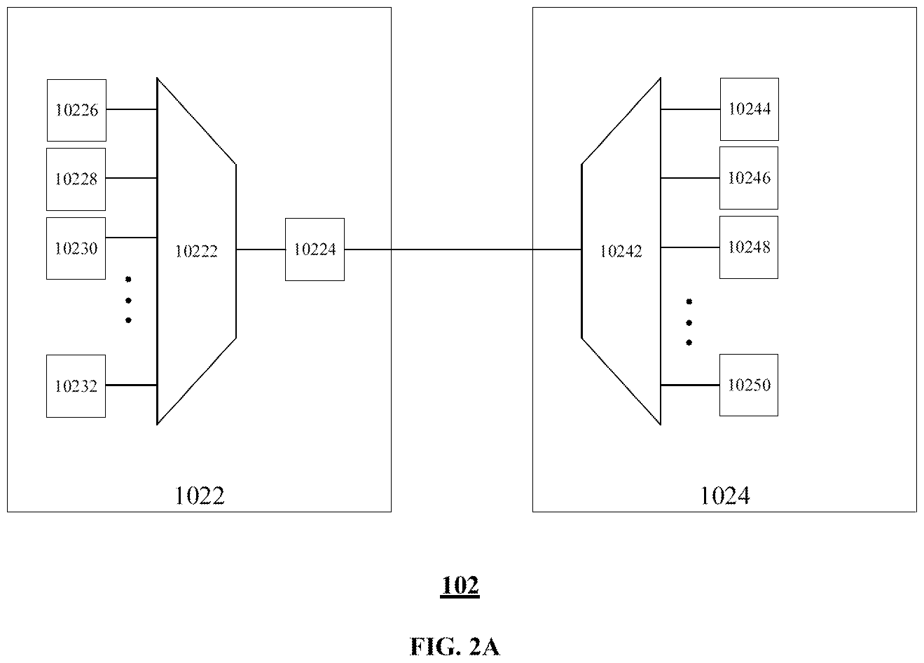

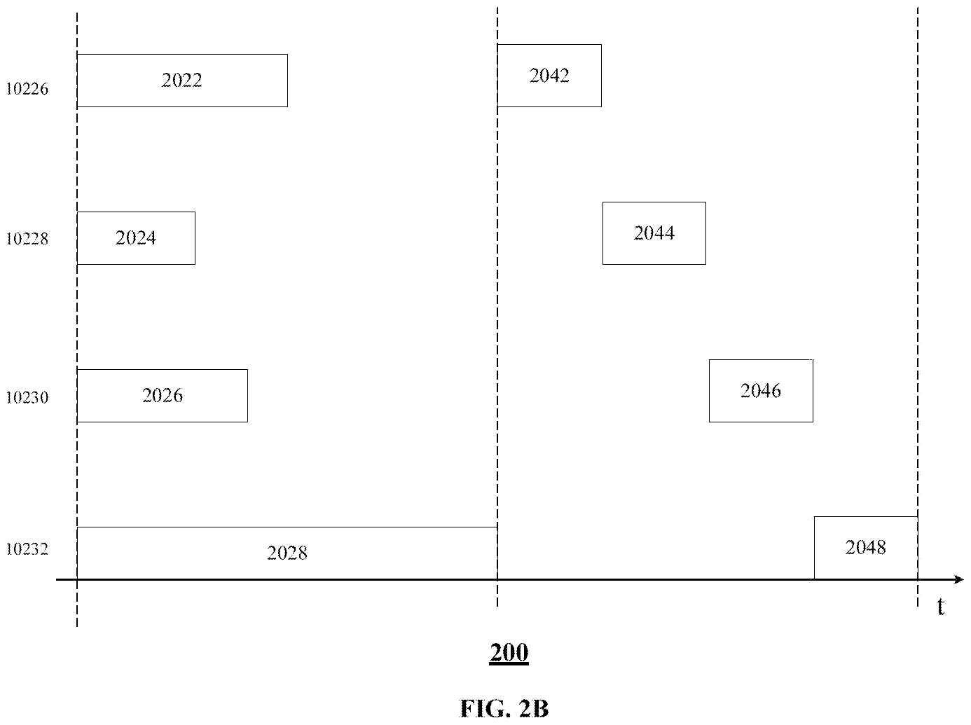

FIG. 2A illustrates a schematic diagram of an emulator 102 according to embodiments of the present disclosure.

As shown in FIG. 2A, emulator 102 can include verification boards (or FPGAs) 1022 and 1024, and communication between verification boards (or FPGAs) 1022 and 1024 can be implemented via a selector (MUX) 10222 or 10242 for time division multiplexing (TDM). Each selector 10222 or 10242 can connect a plurality of modules. Because each module is implemented as a netlist for the emulator, a module is sometimes referred to as a net. A module can further include one or more sub-modules to be verified. The output of a module (e.g., FF 10226, 10228, 10230, or 10232) can be selected via a MUX (e.g., MUX 10222) and sent to the MUX (e.g., MUX 10242) on the receiving side under the trigger of a flip-flop (FF) 10224. A MUX (e.g., MUX 10242) on the receiving side can select the received signal and transmit the signal to the corresponding target module triggered by the FF (e.g., FF 10244, 10246, 10248, or 10250) connected to the corresponding target module. In the process of this signal transmission, a specific delay can occur.

FIG. 2B illustrates a schematic diagram of a delay generated by a verification board 1022 during data transmission according to embodiments of the present disclosure.

Taking MUX 10222 connecting 4 modules as an example, as shown in FIG. 2B, module 10226 can have an internal delay 2022 (the delay from module 10226 to MUX 10222), module 10228 can have an internal delay 2024, module 10230 can have an internal delay 2026, and module 10232 can have an internal delay 2028. At the same time, there are transmission delays 2042, 2044, 2046, and 2048 in the signal transmission from the verification board 1022 to the verification board 1024. In general, it is considered that the transmission delays 2042, 2044, 2046, and 2048 can be equal because the transmission lines between the verification boards are fixed.

It can be understood that the sum of the internal delay and the transmission delay is the total delay between the two modules on different verification boards.

Because the internal delays 2022, 2024, 2026, and 2028 can have different values (as shown in FIG. 2B, for example, delay 2028 is the longest and delay 2024 is the shortest), it is generally considered that the delay between the two verification boards is Max (internal delay 2022, 2024, 2026, 2028)+4×transmission delay.

Due to the increased size of chip designs, in many cases, the design needs to be split and emulated on a plurality of verification boards (or FPGAs) in the emulator. Then communication between different verification boards is needed. As mentioned earlier, there are bound to be delays in communication across the boards, and these delays can cause actions to be out of synchronization between the different boards.

It is noted that, for the emulator structure of FIG. 2A, in many cases, the output of the module does not change. That is, there is no value in consuming a lot of delay for this module to keep communications synchronized. In view of this feature, embodiments of the present disclosure provide an event-driven synchronization method and an emulator for adjusting clocks.

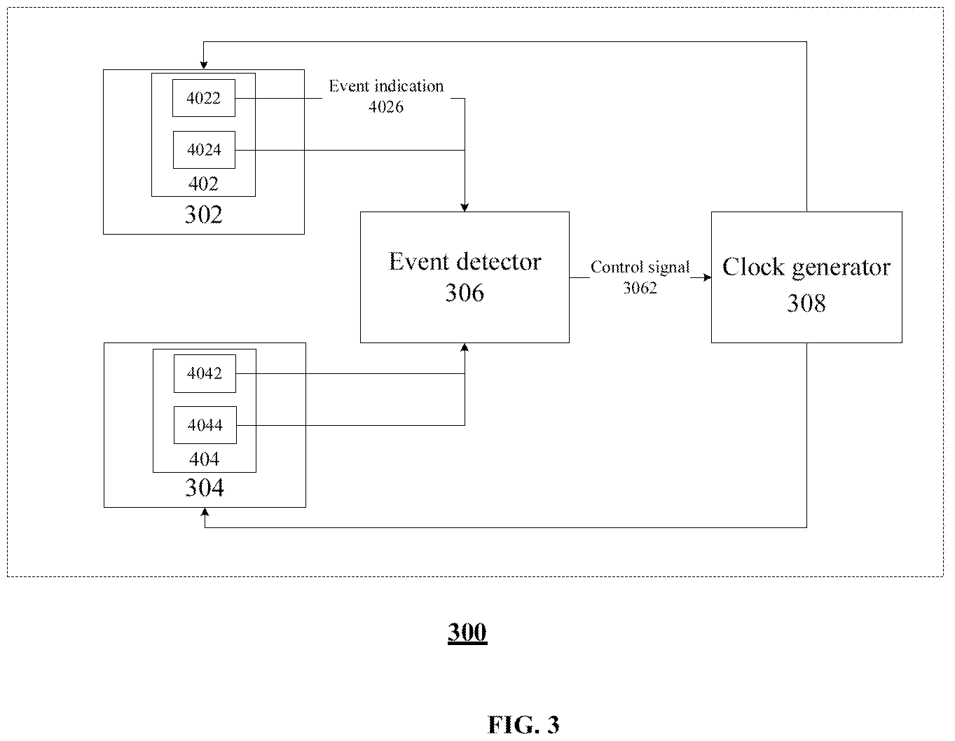

FIG. 3 illustrates a schematic diagram of an exemplary emulator 300 according to embodiments of the present disclosure. Emulator 300 can be used to emulate the logic system design to verify that the functions that the logic system design is expected to accomplish are correctly implemented.

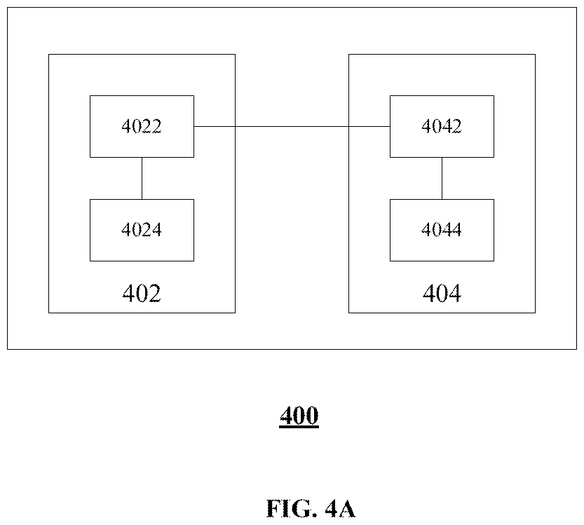

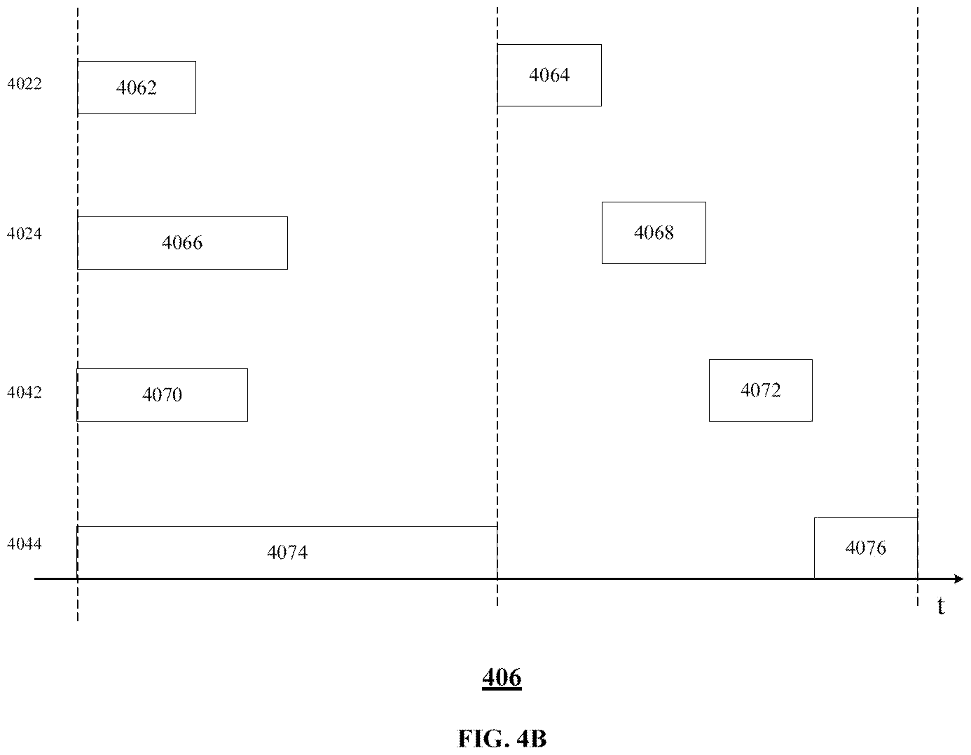

FIG. 4A illustrates a schematic diagram of an exemplary logic system design 400 according to embodiments of the present disclosure. As shown in FIG. 4A, logic system design 400 can include modules 402 and 404. Module 402 can further include sub-modules 4022 and 4024, and module 404 can further include sub-modules 4042 and 4044.

Emulator 300 can be used to emulate design 400 and can further include FPGA 302 and FPGA 304 (as shown in FIG. 3). FPGA 302 and FPGA 304 can be respectively arranged on different verification boards, and one single verification board can be provided with a plurality of FPGAs. While emulating design 400, module 402 of design 400 can run on FPGA 302 of emulator 300 and module 404 can run on FPGA 304 of emulator 300.

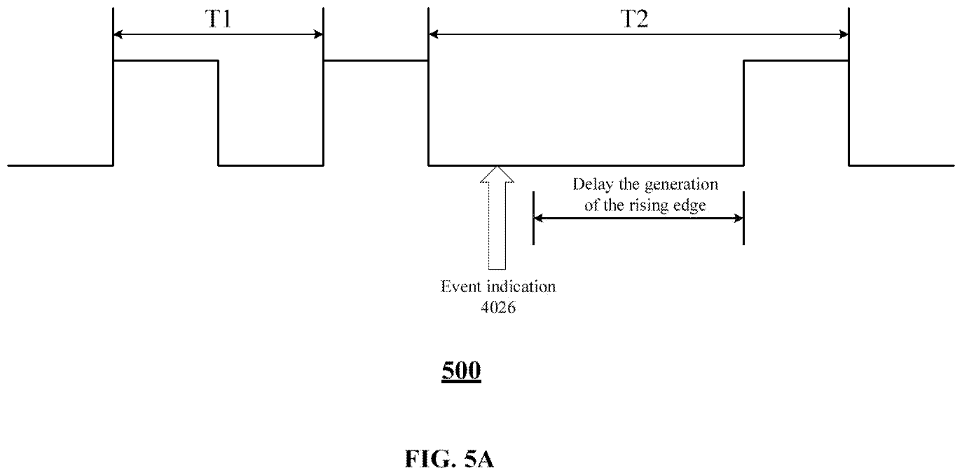

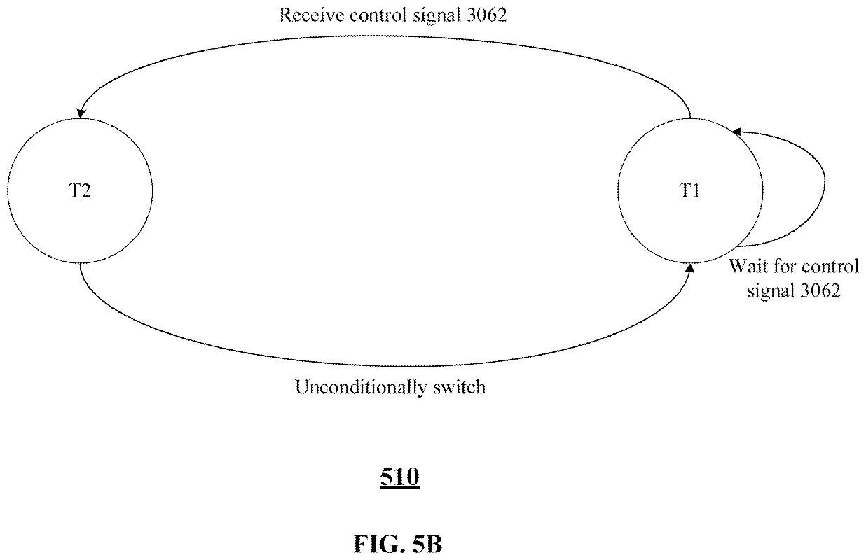

Emulator 300 can run design 400 based on a system clock. FIG. 5A illustrates a schematic diagram of an exemplary system clock 500 according to embodiments of the present disclosure. When emulator 300 emulates design 400, the system clock can be used to run module 402 and module 404, and the communication synchronization between module 402 and module 404 can be realized based on system clock 500.

Returning to FIG. 3, emulator 300 can also include an event detector 306 and a clock generator 308. Event detector 306 can be coupled to sub-modules 4022, 4024 of module 402 and sub-modules 4042, 4044 of module 404, and can detect whether sub-modules 4022, 4024, 4042, or 4044 generate an event indication (e.g., the data of a sub-module has changed and the changed data needs to be transmitted out). Clock generator 308 can be used to generate system clock 500 and can be coupled to event detector 306 to receive a control signal 3062 of event detector 306. Under normal circumstances, when sub-modules of design 400 do not generate any new event, clock generator 308 can generate system clock 500 with a first clock period T1 at a higher frequency, so that emulator 300 can run design 400 at a faster speed while emulating design 400. Clock generator 308 can also generate system clock 500 with a second clock period T2 at a lower frequency, so that emulator 300 can ensure the synchronization of the various modules while emulating design 400.

At a certain moment, for example, sub-module 4022 generates event indication 4026 to indicate event detector 306 that a new event has occurred in this sub-module 4022 (e.g., the data of sub-module 4022 has changed and needs to be transmitted out). After receiving event indication 4026, event detector 306 can send out a control signal 3062 to clock generator 308, so that clock generator 308 can switch the period of system clock 500 from the first clock period T1 to the second clock period T2, which has a lower frequency (that is, the second clock period T2 is greater than the first clock period T1). And, the data of sub-module 4022 can be sent out in the second clock period T2.

After system clock 500 is switched to the second clock period T2, emulator 300 can run sub-module 4022 based on the second clock period T2, so as to output the output signal of sub-module 4022 in the second clock period T2, for example, to module 404. It can be understood that, after system clock 500 is switched to the second clock period T2, in addition to running the sub-module 4022 to output the output signal of sub-module 4022, emulator 300 also needs to run design 400 as a whole to ensure the normal operation of the overall function of design 400. In some embodiments, when emulator 300 runs other modules or sub-modules in design 400 other than sub-module 4022 where the new event occurs, it can be implemented based on signals known to the other modules or sub-modules.

In other words, clock generator 308 can generate a clock signal with two periods (or frequencies), i.e., a first clock period T1 and a second clock period T2. Accordingly, clock generator 308 also includes two states. Here, to simplify the description, for clock generator 308, a state in which the signal of the first clock period is generated is referred to as T1, and a state in which the signal of the second clock period is generated is referred to as T2.

FIG. 5B illustrates a schematic diagram of an exemplary state machine 510 of a clock generator 308 according to embodiments of the present disclosure. As shown in FIG. 5B, when clock generator 308 is in the T1 state, the next state of T1 is generally still T1. That is to say, in general, clock generator 308 can continuously generate a clock signal whose clock period is T1. When clock generator 308 receives control signal 3062, clock generator 308 enters the T2 state. That is, clock generator 308 generates a clock signal with a clock period of T2. The next state to the T2 state is the T1 state. That is, when the clock signal with the clock period T2 ends, clock generator 308 enters the T1 state, and accordingly generates the clock signal with the clock period T1.

In some embodiments, event indication 4026 can include information indicating a change in the output signal of sub-module 4022 and information indicating a delay of sub-module 4022. The information indicating a change in the output signal of sub-module 4022 enables event detector 306 to determine that a new event has occurred in sub-module 4022 after receiving event indication 4026. Emulator 300 can determine the second clock period T2 according to the information indicating a delay of sub-module 4022, so as to ensure that sub-module 4022 can complete data transmission in the second clock period T2.

FIG. 4B illustrates a schematic diagram of a delay of a sub-module of a design 400 according to embodiments of the present disclosure.

In some embodiments, as shown in FIG. 4B, delays of sub-modules 4022, 4024, 4026, 4028 can include internal delays 4062, 4066, 4070, and 4074 of sub-modules 4022, 4024, 4026, and 4028, and transmission delays 4064, 4068, 4072, and 4076 between module 402 and module 404.

When the second clock period T2 is determined based on event indication 4026 of sub-module 4022, it can be determined according to the internal delay and the transmission delay of sub-module 4022. For example, the second clock period T2 is set to be greater than or equal to the sum of internal delay 4062 and transmission delay 4064 of sub-module 4022, thereby ensuring that sub-module 4022 can complete data transmission in the second clock period T2.

In some other embodiments, to ensure that sub-module 4022 can complete the data transmission in the second clock period T2 and avoid the situation that the data transmission cannot be completed in the second clock period T2 as much as possible, the second clock period T2 can be set longer than the above sum. For example, the second clock period T2 can be set to be greater than or equal to the sum of internal delay 4066 and transmission delay 4068 of a sub-module (e.g., sub-module 4024) having a longest internal delay of sub-modules 4022 and 4024 of module 402.

It can be understood that, the foregoing embodiments of setting the second clock period T2 can ensure that the sub-module that generates the new event can output data in the second clock period T2 while the second clock period T2 is set to be as short as possible, so that the emulation can be operated at a high speed as much as possible. However, in order to ensure that the data can be transmitted better and make the overall design of the emulation system as simple as possible, the second clock period T2 can be set to a fixed value that is long enough, rather than setting the second clock period T2 according to the sub-module that generates a new event or the delays of sub-modules in the same module. In this way, as long as event detector 306 receives the event indication, clock generator 308 can switch system clock 500 to the fixed value, and no additional calculation is required. In some embodiments, the fixed value can be determined according to a maximum value of internal delays of all sub-modules in design 400 in together with the transmission delay.

In some embodiments, event detector 306 can generate a clock stop instruction, which can pull up a stop line that controls clock generator 308, based on event indication 4026. The pulled-up stop line can cause clock generator 308 to delay the generation of the rising edge of the clock signal of system clock 500 (as shown in FIG. 5), so as to switch the period of system clock 500 from the first clock period T1 to the second clock period T2.

After the system clock 500 is switched to the second clock period T2 and the duration of the second clock period T2 has elapsed, event detector 306 can send the control signal 3062 to clock generator 308 again, so that clock generator 308 switches the period of system clock 500 from the second clock period T2 to the first clock period T1 to resume the fast emulation of emulator 300.

In some embodiments, event detector 306 can generate a clock generation instruction (e.g., pulling down the stop line that controls clock generator 308) to cause clock generator 308 to generate the rising edge of the clock signal of system clock 500, so as to switch the period of system clock 500 from the second clock period T2 to the first clock period T1.

It can be seen that, in the emulator provided by embodiments of the present disclosure, an event detector can be provided to couple to sub-modules of a design, so that the event detector can lengthen the period of the system clock upon detecting a new event and shorten the period of the system clock if no new event is detected, and thus, it can improve the emulation speed and the emulation efficiency.

Embodiments of the present disclosure also provide a method for synchronizing a first module and a second module of a logic system design, for improving the emulation efficiency to a certain extent.

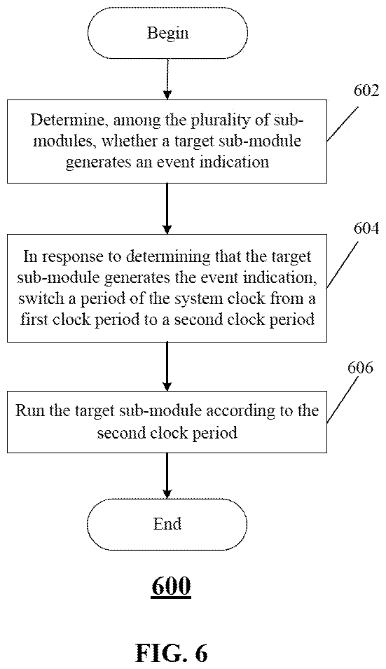

FIG. 6 is a flowchart of an exemplary synchronization method 600 according to embodiments of the present disclosure. Method 600 can be implemented by emulator 300 as shown in FIG. 3, and can be used to synchronize first module 402 and second module 404 of logic system design 400 as shown in FIG. 4A, first module 402 and second module 404 can operate according to system clock 500 as shown in FIG. 5.

In some embodiments, emulator 300 can include a first FPGA 302 and a second FPGA 304, first module 402 can run on first FPGA 302, and second module 404 can run on second FPGA 304. As shown in FIG. 6, method 600 can include the following steps.

At step 602, emulator 300 can determine, among a plurality of sub-modules (e.g., sub-modules 4022, 4024, 4026, and 4028 of FIG. 4A), whether a target sub-module (e.g., sub-module 4022 of FIG. 4A) generates an event indication. For example, emulator 300 can determine, via event detector 306 of FIG. 3, whether the target sub-module generates an event indication. It can be understood that the target sub-module can be any one of a plurality of sub-modules.

At step 604, in response to determining that the target sub-module generates the event indication (e.g., event indication 4026 of FIG. 3), emulator 300 can switch a period of a system clock (e.g., system clock 500 of FIG. 5) from a first clock period (e.g., period T1 of FIG. 5) to a second clock period (e.g., period T2 of FIG. 5), wherein, the first clock period can be less than the second clock period.

In some embodiments, the event indication can include information indicating a change in an output signal of the target sub-module and information indicating a delay of the target sub-module. Method 600 can further include: emulator 300 determining the second clock period according to the delay of the target sub-module.

In some embodiments, the delay of the target sub-module can include an internal delay (e.g., internal delay 4062 of FIG. 4B) of the target sub-module and a transmission delay (e.g., transmission delay 4064 of FIG. 4B) between the first module and the second module, the second clock period can be greater than or equal to the sum of the internal delay and the transmission delay of the target sub-module, thereby ensuring that sub-module 4022 can complete data transmission in the second clock period T2.

In some other embodiments, the delay of sub-modules (e.g., sub-modules 4022 and 4024 of FIG. 4A) of the first module can include an internal delay of each sub-module (e.g., internal delay 4062 or 4066 of FIG. 4B) and a transmission delay between the first module and the second module (e.g., transmission delay 4064 or 4068 of FIG. 4B), the second clock period can be greater than or equal to a sum of the internal delay (e.g., internal delay 4066 of FIG. 4B) of a sub-module having a longest internal delay among the plurality of sub-modules of the first module and the transmission delay (e.g., transmission delay 4068 of FIG. 4B). And thus, it is ensured that the target sub-module can complete the data transmission in the second clock period and avoid the situation that the data transmission cannot be completed in the second clock period as much as possible.

In some embodiments, emulator 300 switching the period of the system clock from the first clock period to the second clock period can further include: emulator 300 generating a clock stop instruction according to the event indication, so as to delay generation of a rising edge of the clock signal of the system clock.

At step 606, emulator 300 can run the target sub-module according to the second clock period.

In some embodiments, emulator 300 running the target sub-module according to the second clock period can include: emulator 300 outputting the output signal of the target sub-module in the second clock period, so as to transmit the data corresponding to the new event of the sub-module to, for example, module 404.

In some embodiments, method 600 can further include: in response to elapsing a second clock period, emulator 300 switching the period of the system clock from the second clock period to the first clock period, so that emulator 300 can resume a fast emulation speed.

In some embodiments, emulator 300 switching the period of the system clock from the second clock period to the first clock period further includes: emulator 300 generating a clock generation instruction to generate a rising edge of the clock signal of the system clock.

Embodiments of the disclosure can lengthen the period of the system clock upon a new event is detected, and run the design with a shorter period if no new event is detected, and therefore the emulation speed and efficiency can be improved.

Those skilled in the art can easily derive other embodiments of the present disclosure after considering and practicing the above disclosure. The present disclosure is aimed at covering any variations, use or adaptive changes of the present disclosure, and the variations, use or adaptive changes conform to the general principle of the present disclosure and include common knowledge or common technical means in the technical field not disclosed in the present disclosure. The specification and embodiments are merely regarded as exemplary, and the scope of the invention is defined by the accompanied claims.

It should be understood that the present disclosure is not limited to the accurate structure described above and illustrated in the drawings, and various modifications and changes can be made without departing from the scope thereof. The scope of the invention is only limited by the appended claims.

What is claimed is:

1. A method for synchronizing a first module and a second module of a logic system design, wherein the first module and the second module operate according to a system clock, the first module includes a plurality of sub-modules, the method comprising:
determining, among the plurality of sub-modules, whether a target sub-module generates an event indication;
in response to determining that the target sub-module generates the event indication, switching a period of the system clock from a first clock period to a second clock period, wherein the first clock period is less than the second clock period; and
running the target sub-module according to the second clock period.

2. The method of claim 1, wherein the logic system design is implemented on an emulator, the emulator comprising a first Field Programmable Gate Array (FPGA) and a second FPGA, the first module runs on the first FPGA, and the second module runs on the second FPGA.

3. The method of claim 1, wherein the event indication comprises information indicating a change in an output signal of the target sub-module and information indicating a delay of the target sub-module, and the method further comprises:
determining the second clock period according to the delay of the target sub-module.

4. The method of claim 3, wherein the delay of the target sub-module comprises an internal delay of the target sub-module and a transmission delay between the first module and the second module, the second clock period being greater than or equal to a sum of the internal delay of the target sub-module and the transmission delay.

5. The method of claim 3, wherein a delay of one sub-module of the plurality of sub-modules comprises an internal delay of the one sub-module and a transmission delay between the first module and the second module, the second clock period being greater than or equal to a sum of the internal delay of a sub-module having a longest internal delay among the plurality of sub-modules and the transmission delay.

6. The method of claim 1, further comprising:
in response to elapsing the second clock period, switching the period of the system clock from the second clock period to the first clock period.

7. The method of claim 6, wherein switching the period of the system clock from the second clock period to the first clock period further comprises:
generating a clock generation instruction, to start generation of a rising edge of a clock signal of the system clock.

8. The method of claim 1, wherein switching the period of the system clock from the first clock period to the second clock period further comprises:
generating a clock stop instruction according to the event indication, to delay generation of a rising edge of a clock signal of the system clock.

9. The method of claim 1, wherein running the target sub-module according to the second clock period comprises:
outputting an output signal of the target sub-module in the second clock period.

10. An emulator for synchronizing a first module and a second module of a logic system design, comprising:
an interface unit configured to be connected to a host;
a memory storing a set of instructions; and
at least one processor configured to execute the set of instructions to perform a method for synchronizing the first module and the second module of the logic system design, wherein the first module and the second module operate according to a system clock, the first module includes a plurality of sub-modules, the method comprising:
determining, among the plurality of sub-modules, whether a target sub-module generates an event indication;
in response to determining that the target sub-module generates the event indication, switching a period of the system clock from a first clock period to a second clock period, wherein the first clock period is less than the second clock period; and
running the target sub-module according to the second clock period.

11. The emulator of claim 10, further comprising a first Field Programmable Gate Array (FPGA) and a second FPGA, the first module running on the first FPGA and the second module running on the second FPGA.

12. The emulator of claim 10, wherein the event indication comprises information indicating a change in an output signal of the target sub-module and information indicating a delay of the target sub-module, and the at least one processor is further configured to execute the set of instructions to:
determine the second clock period according to the delay of the target sub-module.

13. The emulator of claim 12, wherein the delay of the target sub-module comprises an internal delay of the target sub-module and a transmission delay between the first module and the second module, the second clock period being greater than or equal to a sum of the internal delay of the target sub-module and the transmission delay.

14. The emulator of claim 12, wherein a delay of one sub-module of the plurality of sub-modules comprises an internal delay of the one sub-module and a transmission delay between the first module and the second module, the second clock period being greater than or equal to a sum of the internal delay of a sub-module having a longest internal delay among the plurality of sub-modules and the transmission delay.

15. The emulator of claim 10, wherein the at least one processor is further configured to execute the set of instructions to:
in response to elapsing the second clock period, switch the period of the system clock from the second clock period to the first clock period.

16. The emulator of claim 15, wherein the at least one processor is further configured to execute the set of instructions to:
generate a clock generation instruction, to start generation of a rising edge of a clock signal of the system clock.

17. The emulator of claim 10, wherein the at least one processor is further configured to execute the set of instructions to:
generate a clock stop instruction according to the event indication, to delay generation of a rising edge of a clock signal of the system clock.

18. The emulator of claim 10, wherein the at least one processor is further configured to execute the set of instructions to:
output an output signal of the target sub-module in the second clock period.

19. A non-transitory computer-readable storage medium storing a set of instructions that, when executed by an emulator, causes the emulator to perform a method for synchronizing a first module and a second module of a logic system design, wherein the first module and the second module operate according to a system clock, the first module includes a plurality of sub-modules, the method comprising:
determining, among the plurality of sub-modules, whether a target sub-module generates an event indication;
in response to determining that the target sub-module generates the event indication, switching a period of the system clock from a first clock period to a second clock period, wherein the first clock period is less than the second clock period; and
running the target sub-module according to the second clock period.
